(19) United States
(12) Patent Application Publication
(10) Pub. No.: US 2011/0271817 A1
(43) Pub. Date: Nov. 10, 2011

(54) DRUM-KIT RACK SYSTEM

(76) Inventor: CHAO-YING HSIEN, Taichung City (TW)

(21) Appl. No.: 12/943,029

(22) Filed: Nov. 10, 2010

(30) Foreign Application Priority Data
May 5, 2010 (TW) 099208345

(51) Int. Cl. G10D 13/02

(52) U.S. Cl. 84/421

(57) ABSTRACT

A drum-kit rack system allows a bass drum and a hi-hat cymbal of a drum-kit to be attached to the drum-kit rack system. The bass drum is combined with the drum-kit rack system at a lower space of the drum-kit rack system defined by a horizontal bar and two abreast vertical posts of the drum-kit stand, while the hi-hat cymbal is combined with the drum-kit rack system at an open end of the horizontal bar or an extension rod. In virtue of the structure and spectral configuration of the drum-kit rack system, the bass drum and the hi-hat cymbal can be reliably positioned and prevented from sliding away when receiving a beating force.

### BACKGROUND OF THE INVENTION

1. Technical Field

The present invention relates to drum-kit rack system, and more particularly, to a drum-kit rack capable of holding a bass drum and a hi-hat cymbal.

2. Description of Related Art

A drum kit is typically composed of a bass drum, tenor drums, snare drums, and a hi-hat cymbal. All the drums are fixed to a drum-kit rack system except the bass drum 1. The bass drum 1 is usually placed below the drum-kit rack system and stands on the ground by means of two support rods 11 that extend from a shell thereof. To drum the bass drum 1, a drummer may step down a bass-drum pedal 2 to make the bass drum 1 beaten (referring to FIG. 1). However, since the bass drum 1 is independently standing on the ground, it is likely to slide away from the drummer in response to the beating force. The current approach to this problem is to lay an anti-slip carpet between the bass drum 1 and the ground yet the improvement is far from being satisfactory.

The same problem happens to the hi-hat cymbal 3. Referring to FIG. 2, the hi-hat cymbal support 31 stands independently from the drum-kit with its two legs 32. Although the two legs 32 do secure the hi-hat-cymbal support 31 from falling, when the drummer steps a pedal 33 to play the hi-hat cymbal 3, there is no means to brake and position the hi-hat-cymbal support 31 from sliding away from the drummer under the beating force. This also brings inconvenience to the drummer. Hence, a solution is needed to overcome the above problems.

### SUMMARY OF THE INVENTION

The objective of the present invention is to improve the conventional drum-kit whose bass drum and hi-hat cymbal stand independently from its drum-kit rack system without any effective positioning structure and slide away under a beating force. To achieve the objective, the present invention combines the bass drum and the hi-hat cymbal to the drum-kit rack. Particularly, the bass drum is deposited in a space defined by a horizontal bar and two vertical posts of the drum-kit rack system while the hi-hat cymbal is attached to and open end of the horizontal bar or an extension rod of the drum-kit stand. In virtue of the structure and spectral configuration provided by the present invention, the bass drum and the hi-hat cymbal can be reliably positioned and prevented from sliding away when receiving a beating force, thereby perfectly solving the problems of the prior art.

### BRIEF DESCRIPTION OF THE DRAWINGS

The invention as well as a preferred mode of use, further objectives and advantages thereof will be best understood by reference to the following detailed description of an illustrative embodiment when read in conjunction with the accompanying drawings, wherein:

FIG. 1 is a schematic drawing of a conventional bass drum;

FIG. 2 is a schematic drawing of a conventional hi-hat cymbal;

FIG. 3 is a schematic structure drawing of the present invention;

FIG. 4 is another schematic structure drawing of the present invention_{;}

FIG. 5 is a partial enlarged view of the present invention showing a bass drum is combined with the drum-kit rack system;

FIG. 6 is a partial enlarged view of the present invention showing a hi-hat cymbal is combined with the drum-kit rack system; and

FIG. 7 is a schematic drawing showing the hi-hat cymbal bottomed with an anti-slip member according to the present invention.

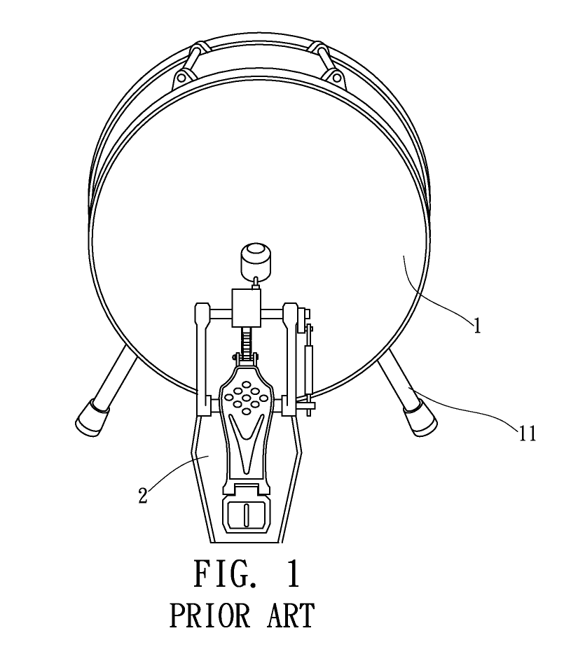

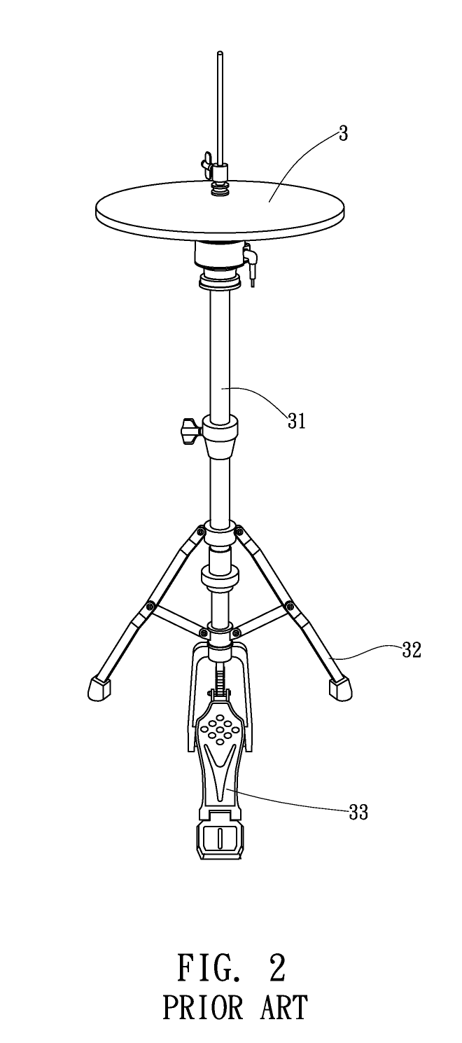

### DETAILED DESCRIPTION OF THE INVENTION

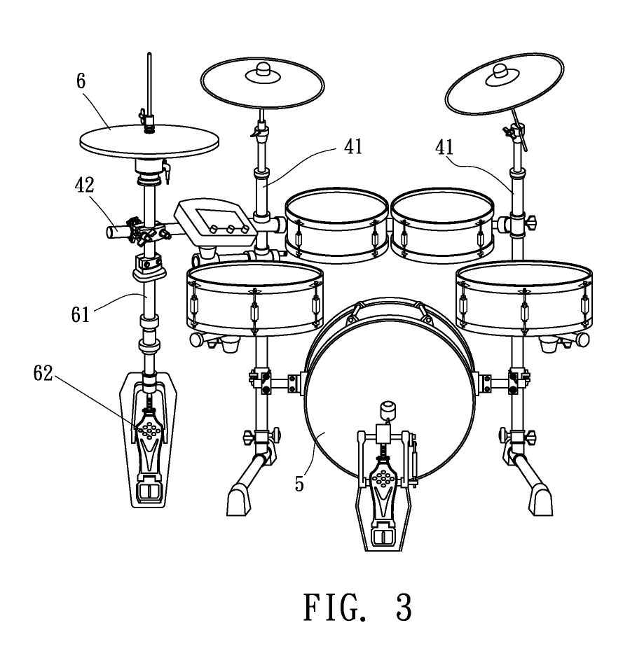

Please refer to FIG. 3 for a drum-kit rack system 4 provided by the present invention. The drum-kit rack system 4 comprises:

at least two abreast vertical posts 41, both coupled with a horizontal bar 42; and

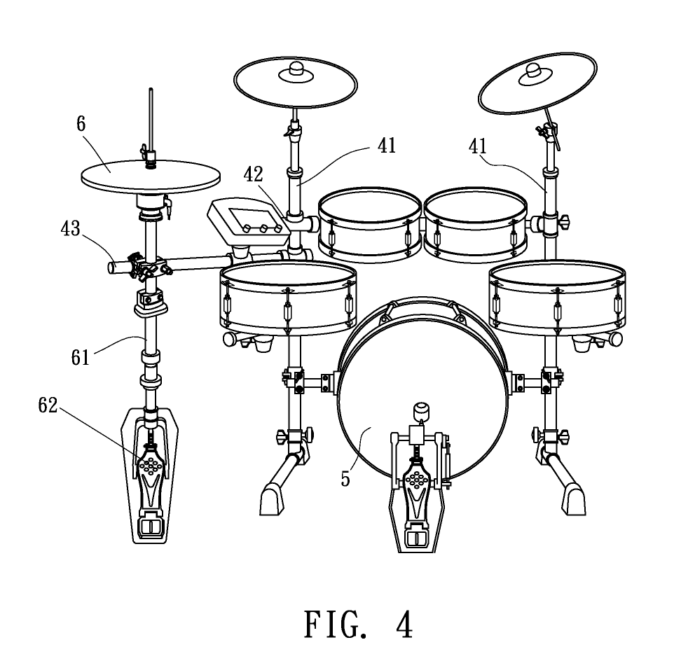

a horizontal extension bar 43 further coupled to one of the vertical posts 41, as shown in FIG. 4.

Therein, the horizontal bar 42 and the horizontal extension bar 43 serve to support all drums of various sizes in a drum kit.

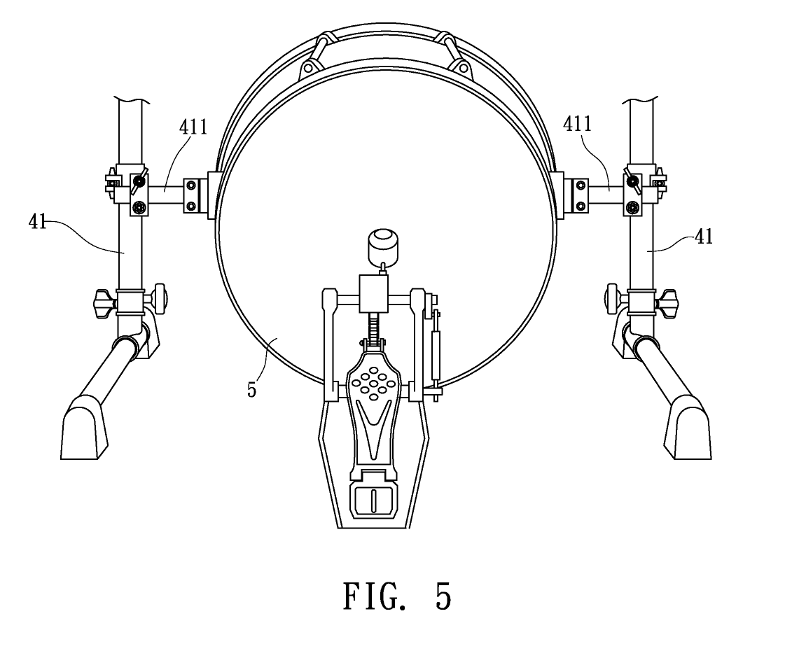

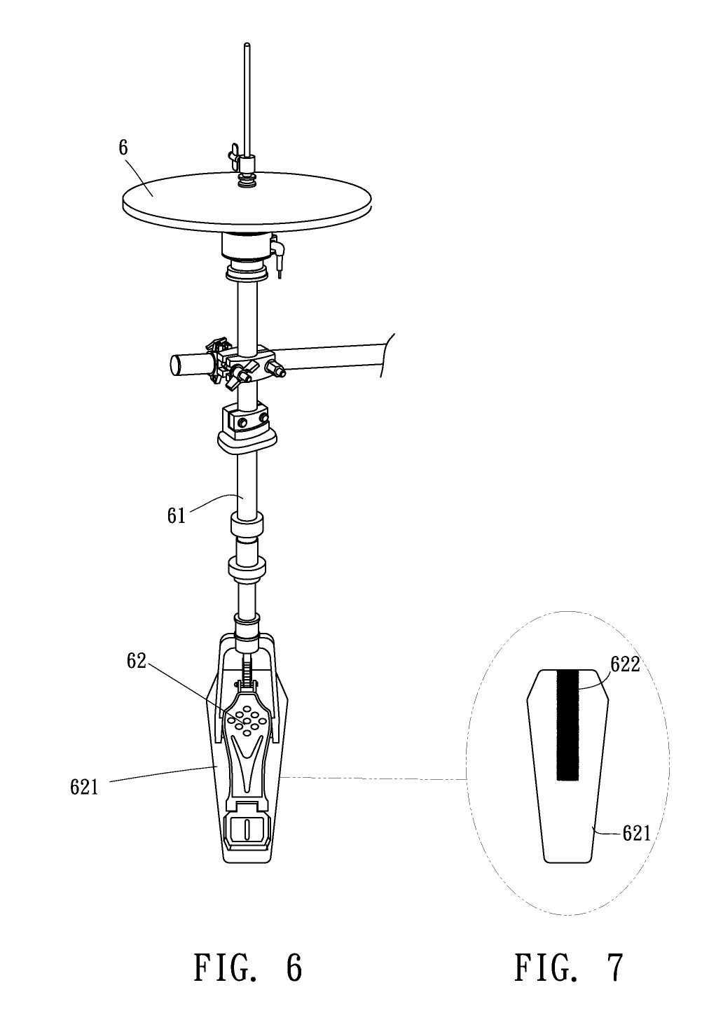

In a lower space defined by the two vertical posts 41 and the horizontal bar 42 of the drum-kit rack system 4, a bass drum 5 of the drum kit is combined to and positioned by the drum-kit rack system 4. Therein, the two abreast vertical posts 41 may each have at least one combining arm 411 that jointly hold the bass drum 5 drum shell, as shown in FIG. 5.

In addition, the horizontal bar 42 may have at least one combining arm (not shown) to be coupled with a drum shell of the bass drum 5.

Moreover, near an open end of either the horizontal bar 42 or the horizontal extension bar 43, a hi-hat cymbal support 61 of a hi-hat cymbal 6 may be fixed and positioned, as shown in FIG. 3 and FIG. 4.

A pedal 62 of the hi-hat cymbal 6 has a base 621 with a flat bottom, on which at least one anti-slip member 622 is provided, as shown in FIG. 7.

In virtue of the above structure, no matter how crazily a drummer steps a pedal of 62 the bass drum 5, the bass drum 5 can be reliably positioned. Thereby, the bass drum 5 needs not to be equipped with support rods as those used in the prior art, and it is unnecessary to have an anti-slip carpet laid below the bass drum 5.

Since the hi-hat cymbal 6 is combined with the drum-kit rack system 4, there is no need to use the conventionally attached legs for supporting the hi-hat cymbal 6, so as to compact the drum kit and thereby save space. In addition, by being combined to the drum-kit rack system 4, the hi-hat cymbal 6 can be well positioned. Particularly, the anti-slip member 622 provided at the base 621 of the pedal 62 further improves the stability of the hi-hat cymbal 6.

In virtue of the above-mentioned components and configuration, costs otherwise for auxiliaries such as a tripod or supporting rods can be saved and transportation of the drum kit can be easy during travel.

What is claimed is:

1. A drum-kit rack system, comprising at least two abreast vertical posts that are coupled to a horizontal bar and being characterized in that:
the drum-kit rack system has a lower space defined by the two vertical posts and the horizontal bar, and a bass drum of a drum-kit is deposited in the space and attached to the drum-kit rack system.

2. The drum-kit rack system of claim 1, wherein each of the abreast vertical posts has at least one combining arm for holding a shell of the bass drum.

3. The drum-kit rack system of claim 1, wherein the horizontal bar has at least one combining arm for holding a shell of the bass drum.

4. The drum-kit rack system of claim 1, wherein each of the abreast vertical posts and the horizontal bar has at least one combining arm for holding a shell of the bass drum.

5. The drum-kit rack system of claim 1, wherein a support of a hi-hat cymbal is fixedly attached to the horizontal bar of the drum-kit stand near an open end of the horizontal bar.

6. The drum-kit rack system of claim 1, wherein a horizontal extension bar is attached to the vertical posts and has an open end near where a support of a hi-hat cymbal is affixed.

7. The drum-kit rack system of claim 5 or 6, wherein the hi-hat cymbal has a base with a flat bottom, and at least one anti-slip member is provided on the flat bottom.
